(19) United States
(12) Patent Application Publication
(10) Pub. No.: US 2016/0096424 A1
(43) Pub. Date: Apr. 7, 2016

(54) OPERATING SPACE WITH A PREFERABLY THERMALLY AND ACOUSTICALLY INSULATING ENCLOSURE, AND AIR LOUVER ARRANGEMENT WHICH COOPERATES WITH SAID OPERATING SPACE

(71) Applicant: Röchling Automotive SE & Co. KG, Mannheim (DE)

(72) Inventors: Christian Schiller, Deidesheim (DE); Frank Uhl, Florsheim-Dalsheim (DE)

(21) Appl. No.: 14/872,744

(22) Filed: Oct. 1, 2015

(30) Foreign Application Priority Data
Oct. 2, 2014 (DE) 102014220119.5

(51) Int. Cl. B60K 11/08; B62D 25/08; B60R 13/08; B60K 11/04; B60K 11/06

(52) U.S. Cl. CPC B60K 11/085; B60K 11/04; B60K 11/06; B60R 13/0838; B62D 25/082; B62D 25/084

(57) ABSTRACT

An operating space, particularly for a motor vehicle, which is bounded by an enclosure, wherewith more than half of the enclosure surface comprises a thermally and acoustically insulating lining material, and/or the enclosure surface is formed from insulating lining material, wherein the enclosure cooperates with an air intake louver system at an intake location that includes an air intake passage opening and at least one air intake louver wherein the intake louver(s) is adjustable between an open or passage position which allows passage of air, wherein the air-permeable flow cross section of the air intake opening is greater, and a closed or blocked position wherein the air-permeable flow cross section of the air intake opening is smaller, so that the amount of air per unit time which is admitted into the operating space through the air intake opening is less than when the at least one air intake louver is in the open position.

The present invention relates to an operating space, particularly for a motor vehicle, which space is bounded by an enclosure, wherewith more than half, preferably more than 75%, particularly preferably more than 85%, of the enclosure surface comprises an insulating lining material which is preferably a thermally and acoustically insulating lining material, and/or the enclosure surface is formed from insulating lining material, which is preferably thermally and acoustically insulating lining material.

### BACKGROUND OF THE INVENTION

Such operating spaces having an insulating enclosure, particularly a thermally and acoustically insulating enclosure, are known in the art. An operating space in the form of an engine compartment is an example of such an operating space; there is an increasing tendency for such operating spaces to be lined with thermally insulating lining material, so that when the internal combustion engine is started in a cold start the amount of time needed to reach the specified operating temperature of the engine is reduced. When the engine operates at its specified operating temperature, the engine emits the minimum amount of pollutants in relation to the total amount of exhaust gas.

When it is stated in the present patent application that the operating space is bounded by an enclosure, this does not necessarily mean that the operating space is completely enclosed by the enclosure, although complete enclosure is preferred. Nonetheless, the possibility is left open that there may be gaps between individual surfaces of the enclosure, which gaps allow air exchange between an interior region of the operating space and the surroundings. Under some circumstances, in fact, the conditions of the installation space do not favor a gap-free enclosure of the operating space. E.g., in the case of the operating space being an engine compartment, there may be a gap between the engine compartment hood and the lining of the operating space. However, preferably this is not the case.

Additionally, it should be unnecessary for the entire enclosure to be comprised of or formed from insulating lining material, particularly thermally and acoustically insulating lining material. However, at least half of the enclosure surface should bear such a material or be formed from such a material. Naturally it is preferred for the entire enclosure to be comprised of or formed from such a material.

It is also noted that in general the thermal insulating capability of a material is correlated with its acoustic insulating capability. Accordingly, in the context of the present patent application it will be assumed that thermally insulating materials will also be acoustically insulating materials, and vice versa. The term “thermal and acoustic insulation” does not signify complete blocking of the transmission of thermal and/or acoustic energy, but merely a reduction of the thermal or acoustic energy (noise energy) which may be transmitted through a material per unit time, compared to the same operating situation without thermally and acoustically insulating material. The term “insulation” (i.e. “acoustic insulation”) refers to reduction of detectable noise energy (or noise power) outside the insulation, by blockage of passage of the noise through the material and/or by absorption of the noise.

Further, air louver systems are known in the art, whereby by relative adjustment of one or more air louvers relative to a flow opening, one can change the amount of air entering a region of a motor vehicle per unit of time, and may possibly be able to reduce such air flow to zero.

The underlying problem of the present invention was to fundamentally improve the possibility of temperature control of the interior space of an operating space of the type described initially supra. The type of application envisioned is particularly (but not exclusively) the operating space of a motor vehicle, e.g. the engine compartment.

### SUMMARY OF THE INVENTION

The stated underlying problem is solved according to the invention by an operating space of the type described initially supra, in which the enclosure cooperates with an air intake louver system at an intake location, which air intake louver system is comprised of an air intake louver, preferably a plurality of air intake louvers, which louver(s) is (are) adjustable between an open or passage position which allows passage of air, wherein the air-permeable flow cross section of the air intake passage opening is greater, admitting air through the air intake passage opening into the operating space, and a closed or blocked position wherein the air-permeable flow cross section of the air intake passage opening is smaller, preferably zero, so that, other conditions being equal, the amount of air per unit time which is admitted into the operating space through the air intake passage opening is less than when the at least one air intake louver is in the open position, and preferably is zero.

By means of the cooperation of the air intake louver system and the enclosure of the operating space, the insulating effect, in particular the thermally and acoustically insulating effect, of the lining materials, can be combined with the capability of regulation of the air flow entering the operating space. In this way, it is possible to particularly effectively adjust the heat balance of the interior region of the operating space to achieve a predetermined operating range or operating point. The air intake louver system can be employed to supply an air stream for convective cooling of the interior region of the operating space as required, depending on the number and the operating state of the heat sources present in the operating space.

One may ensure the cooperation of the enclosure of the operating space with the air intake louver system by, e.g., forming the air flow opening directly in a region of the surface of the insulating lining material, which may be in particular a thermally and acoustically insulating lining material, which is part of the enclosure.

As mentioned above in the introduction, it is desirable to have a maximally complete enclosure of the operating space in the sense of “encapsulation” of the operating space, by means of the insulating lining material, which may be in particular a thermally and acoustically insulating lining material.

The more completely the enclosure surrounds the operating space, the more important is the aspect of the outlet of air from the operating space, in addition to the here-discussed supply of cooling air to the operating space through the air intake flow opening. If the operating space, which is accessible from the exterior only by means of appropriate operation of the at least one air intake louver, is completely encapsulated by the enclosure, this will enable sufficient admission of cooling air into the operating space over a relatively long operating time only to a relatively limited degree, because flow through the flow opening enabled by the at least one air intake louver in the open position will lead to a stationary state, in which the in-flowing air must act against the elevated static air pressure in the interior of the operating space caused by the in-flowing air itself.

According to an advantageous refinement of the invention, the enclosure cooperates with an air outlet louver system disposed at an outlet location which is different from the intake location, which air outlet louver system has an air outlet passage opening and at least one air outlet louver, preferably a plurality of air outlet louvers, whereby the at least one air outlet louver is adjustable between an open position, in which the air flow cross section of the air outlet passage opening is greater, so that air can be passed out of the operating space through the air outlet passage opening, and a closed position, in which the air flow cross section of the air outlet passage opening is smaller, preferably zero, so that, other conditions being equal, the amount of air per unit time which can be exhausted from the operating space through the air outlet passage opening is less than when the at least one air outlet louver is in the open position, and preferably is zero.

It should be noted that according to the above description there is only the capability of exhausting air from the operating space through the air outlet passage opening; but it is not necessary that this air exhaust capability be actually exploited.

For particularly effective thermal and acoustic insulation of the operating space without appreciable demand for installation space by the lining material, it may be provided that the insulating material is a thermally and acoustically insulating lining material which has one or more porous layers. These layers may be comprised of fibrous materials or open- or closed-cell foam materials. In order to improve the thermal insulation capability of such porous layers, the thermally and acoustically insulating material may preferably comprise a gas-impermeable blocking or barrier layer, to block convection. This will prevent undesired penetration of air from the operating space to the exterior through the lining material. In this way, one can appreciably shorten the time requirement of the heating phase(s) until the specified operating temperature of the components in the interior of the operating space is reached.

Additionally, for improved acoustic insulation of the operating space, at least one air louver, and preferably all of the air louvers, of an air louver system, particularly the air intake louver system and/or the air outlet louver system, may be comprised of thermally and acoustically insulating material, or may be formed from such material.

Preferably, the thermally and acoustically insulating lining material may have a relatively flat configuration, i.e. with an appreciably shorter dimension in the thickness direction than in the two mutually orthogonal directions which are orthogonal to the thickness direction.

In view of the fact that as a rule the air intake flow opening has air flowing through it in a direction orthogonal to its opening surface, it is possible to achieve a particularly effective adjustment of an operating point of the heat balance of the interior region of the operating space if the air intake flow opening and the air outlet flow opening are disposed a distance apart in the direction orthogonal to the air intake flow opening. This facilitates the flow of air which has flowed through the air intake flow opening and possibly has flowed around operating components present in the operating space, such that said air will reach the air outlet flow opening and be exhausted out of the operating space.

It is possible to enhance this effect of the passage of air through the operating space if the air intake flow opening and the air outlet flow opening at least partially overlap when regarded in the direction orthogonal to the air intake flow opening.

On the other hand, it is basically possible for the air intake flow opening and the air outlet flow opening to be disposed at an angle with respect to each other, thus for one of them to be inclined with respect to the other. However, the air flow through the operating space will be optimized if the air intake flow opening and the air outlet flow opening are disposed parallel to each other.

A preferred embodiment of an operating space comprises an engine compartment of a motor vehicle in which an internal combustion engine and a heat exchanger employing a cooling medium are disposed. The cooling medium heat exchanger is commonly also referred to as a “coolant”. Since it is precisely the heat exchanger employing a coolant which mainly supplies the cooling of the internal combustion engine, wherewith the coolant, which has absorbed heat as it flowed through the engine block of the internal combustion engine, can now release heat there (in the operating space), it is advantageous if the intake flow opening is disposed upstream of the heat exchanger employing the coolant, regarded in the direction of the air flow. At the air intake flow opening the amount of flow of convective cooling air supplied directly to the heat exchanger employing the coolant can be varied, which enables a particularly effective influence on the heating-up time of the internal combustion engine (or generally of the interior region of the operating space) to the desired specified operating temperature.

If the operating space is the engine compartment of a motor vehicle, it ordinarily will have an adjoining tunnel which may be configured to accommodate a drive shaft and/or an exhaust pipe and/or a transmission component. Typically, such a tunnel adjoins the operating space on the side of the operating space which is directed toward the rear of the vehicle, and the tunnel extends in the longitudinal direction of the vehicle from the operating space toward the rear of the vehicle.

Such a tunnel inherently provides a means of passage of outlet air, for admitting and passing of air from the interior region of the operating space.

However, the tunnel, being a hollow space, also can function as a noise conduit, which may have the effect of facilitating undesired transmission of noise from the engine compartment (operating space) into the passenger compartment of the motor vehicle.

For this reason, preferably the air outlet louver system with the at least one air outlet louver may be disposed in the transition region between the engine compartment and the tunnel, so that when the at least one air outlet louver is actuated an influence can thereby be exerted on air flow and/or noise or sound propagation between the engine compartment and the tunnel.

It is possible for the air outlet louver system with the at least one air outlet louver to be completely disposed in the tunnel, in a region close to the engine space, or in particular immediately at the transition locus between the engine compartment and the tunnel; or (less preferable) the air outlet louver system may be disposed completely in the engine compartment, in a region close to the tunnel.

It is possible, as claimed according to the invention, to advantageously reduce noise transmission from the engine compartment into the tunnel and thence into the passenger compartment of a motor vehicle by disposing an air louver system in the transition region between the operating space and the adjoining tunnel. Accordingly, the present invention also relates to an operating space, in particular for a motor vehicle, possibly for accommodating an internal combustion engine, which operating space is delimited by an enclosure, wherein more than half, preferably more than 75%, more preferably more than 85%, of the enclosure surface is comprised of thermally and acoustically insulating lining material and/or is formed from thermally and acoustically insulating lining material, which operating space adjoins a tunnel which tunnel is employed possibly for accommodating a drive shaft and/or an exhaust pipe and/or a transmission component, wherein an air louver system is provided which comprises an air passage opening and at least one air louver, preferably a plurality of air louvers, wherein the at least one air louver is adjustable between an open position in which the opening cross section of the air passage opening is larger and a closed position in which the opening cross section of the air passage opening is smaller, preferably zero, which air louver system is disposed in a transition region from the operating space to the tunnel, such that by actuating the at least one air louver one can influence an air flow and/or a noise or sound propagation between the operating space and the tunnel.

In this connection it should be noted that the cross section of the tunnel in a cross sectional plane orthogonal to the longitudinal axis of the tunnel has a smaller area than a cross section of the engine compartment in a cross sectional plane parallel to the aforesaid cross sectional plane.

In order to achieve additional thermal and acoustic insulation of the tunnel, it may be provided that the tunnel is bounded by a thermally and acoustically insulating lining material, in the region of the tunnel immediately adjoining the operating space.

In this connection, it is preferable if thermally and acoustically insulating lining material is provided on both sides of the air louver system disposed in the transition region between the operating space and the tunnel (which air louver system in the previously described instance was the air outlet louver system), which insulating lining material delimits the tunnel and the engine compartment.

The present invention also relates to a motor vehicle having an operating space configured as described above.

These and other objects, aspects, features and advantages of the invention will become apparent to those skilled in the art upon a reading of the Detailed Description of the invention set forth below taken together with the drawing which will be described in the next section.

### BRIEF DESCRIPTION OF THE DRAWINGS

The invention may take physical form in certain parts and arrangement of parts, a preferred embodiment of which will be described in detail and illustrated in the accompanying drawing which forms a part hereof and wherein:

FIG. 1 is a rough schematic longitudinal cross section view through a front region of a motor vehicle with an engine space as an example of an inventive operating space.

### DESCRIPTION OF PREFERRED EMBODIMENTS

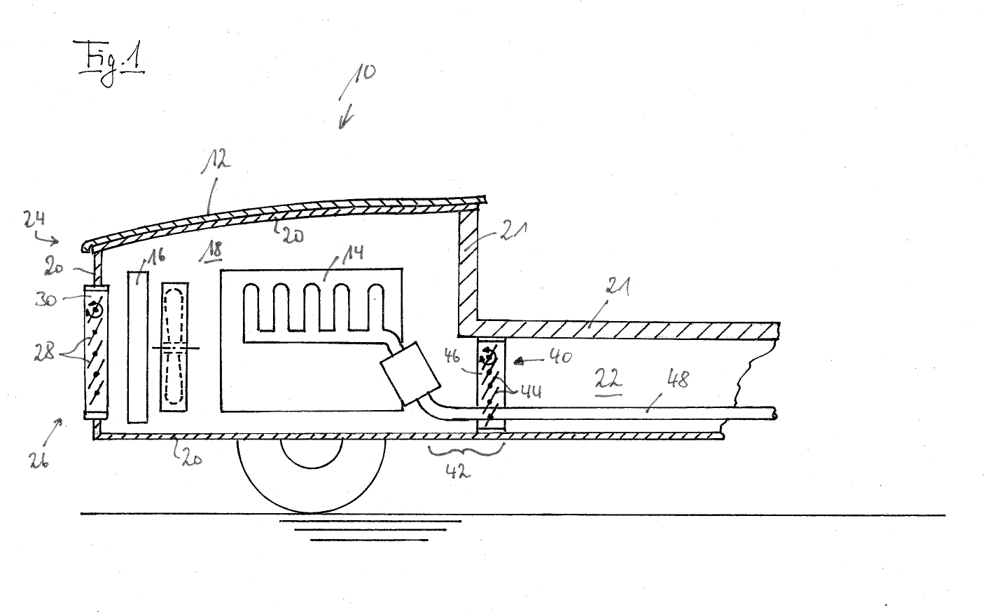

Referring now to the drawing wherein the showings are for the purpose of illustrating preferred and alternative embodiments of the invention only and not for the purpose of limiting the same, FIG. 1, shows a front region of the motor vehicle that is designated with the reference numeral 10. This front region 10 comprises an engine compartment hood 12, with the internal combustion engine 14 disposed below it.

Also disposed in the engine compartment 18 of the vehicle, along with the engine 14, are other components, such as a heat exchanger 16 employing a coolant. The side walls and the hood of the engine compartment 18 are covered with a thermally and acoustically insulating sheet-like lining 20 which thus surrounds the engine compartment. In the direction toward the gasoline tank (not shown), the engine compartment 18 has fireproof lining material 21 which has an insulating fire retardant effect.

A tunnel 22, which may also be surrounded by plate-like thermally and acoustically insulating lining material 20 and may be isolated with fire-retardant lining material, in order to protect the gasoline tank, through which the tunnel passes, against emissions or thermal and noise energy from the tunnel.

An air louver arrangement 26, having a plurality of identical air louvers 28 disposed in an air intake passage opening 30, may be provided on the front end 24 of the vehicle; the louvers 28 may be adjustable between an air admission position and a blocking position. When the louvers 28 are in the air admission position, other conditions being equal, more air per unit time is admitted to the engine compartment 18 than when the louvers 28 are in the blocking position, because in the air admission position the available flow cross section in the air intake passage opening 30 is greater than when the aid admission louvers 28 are in the blocking position.

Air flowing through the engine compartment as a result of the advance of the vehicle or from the action of a fan comes to impinge preferably directly on the heat exchanger 16 which employs a cooling medium, whereby the cooling medium flowing through the heat exchanger can effectively draw away the heat which accumulates in the engine block of the internal combustion engine 14. If the air intake louvers 28 are placed in the blocking position, the supply of convective cooling air into the engine compartment 18 can be reduced or completely cut off. In this way, particularly in a case of cold-starting of the vehicle, the engine 14 can be rapidly heated up to its specified operating temperature, as a result of the reduced cooling; this operating temperature is the temperature at which the engine emits the least amount of pollutants based on the total amount of exhaust gas emitted per unit time.

In order to maximize the lining of the engine compartment 18 by the thermally and acoustically insulating lining material 20, the bottom 32 of the vehicle is configured as a closed bottom, and is provided with plate-shaped thermally and acoustically insulating lining material 20.

The more completely the engine compartment 18 is lined by the thermally and acoustically insulating lining material 20, the more important it is to provide means of outflow of air from the engine compartment 18, so as to allow the convective cooling air which flows into the engine compartment 18 through the air intake opening 30 to displace the hot air which is present there.

In order to achieve maximal enclosure of the engine compartment 18, the volume of the tunnel 22 should be capable of being isolated from the engine compartment 18. For this purpose, an air outlet louver arrangement 40 may be disposed in the tunnel 22 or in a transition region 42 between the engine compartment 18 and the tunnel 22.

The air outlet louver arrangement 40 may have the same basic configuration as the air intake louver arrangement 26, thus it may comprise a plurality of air outlet louvers 44 which can be adjusted between an open or passage position and a closed or blocked position while being disposed in an air outlet passage opening 46, in order to change the air flow cross section of the air outlet passage opening 46. With this feature, the engine compartment 18 can be enclosed more completely than previously with the aid of a lining (20, 21), while still being capable of being rendered permeable by air being exhausted from the engine compartment 18 by adjusting the air outlet louvers 44. Accordingly, it will be possible to effectively influence the convective cooling of components in the engine compartment, in particular the heat exchanger 16 employing a cooling medium, by adjusting the air intake louvers 26 and the air outlet louvers 44.

For maximally efficient flow of cooling air in the engine compartment 18, preferably the air intake flow openings 30 and the air outlet flow opening 46 are preferably arranged at a distance from each other in the flow direction, i.e. in the present example in the longitudinal direction of the vehicle. In addition, preferably the opening surfaces of the two openings 30 and 46 are disposed parallel to each other.

The air outlet louvers 44 may be configured such that they surround the functional units present in the tunnel 22, such as e.g. external transmission components, exhaust pipe 48, and the like, wherewith for example said louvers may have corresponding recesses such that when they are adjusted between the open/passage and closed/blocked position they avoid collision with the functional units.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-11. (canceled)

12. An operating space, particularly for a motor vehicle, which space is bounded by an enclosure, wherein more than half of the enclosure surface comprises an insulating lining material and/or more than half of the enclosure surface is formed from insulating lining material, the enclosure cooperating with an air intake louver system at an intake location, wherein the air intake louver system comprises an air intake passage opening and at least one air intake louver, the at least one air intake louver being adjustable between a passage position, in which the air-permeable flow cross section of the air intake passage opening is greater, so that air can be admitted through the air intake passage opening into the operating space, and a blocking position, in which the air-permeable flow cross section of the air intake passage opening is smaller, so that the amount of air per unit time which can be admitted into the operating space through the air intake passage opening is less than in the passage position.

13. The operating space, particularly for a motor vehicle, according to claim 12, wherein the insulating lining material includes a thermally and acoustically insulating lining material.

14. The operating space, particularly for a motor vehicle, according to claim 12, wherein in the closed position the air-permeable flow cross section of the air intake passage opening is generally zero.

15. The operating space, particularly for a motor vehicle, according to claim 12, wherein the at least one air intake louver is a plurality of air intake louvers.

16. The operating space, particularly for a motor vehicle, according to claim 12, wherein more than 75% of the enclosure surface comprises the insulating lining material.

17. The operating space, particularly for a motor vehicle, according to claim 12, wherein the enclosure cooperates with an air outlet louver system disposed at an outlet location which is different from the intake location, wherein the air outlet louver system comprises an air outlet passage opening and at least one air outlet louver, the at least one air outlet louver being adjustable between an open position, in which the air flow cross section of the air outlet passage opening is greater, so that air can be passed out of the operating space through the air outlet passage opening, and a closed position, in which the air flow cross section of the air outlet passage opening is smaller, so that the amount of air per unit time which can be exhausted from the operating space through the air outlet passage opening is less than in the open position.

18. The operating space, particularly for a motor vehicle, according to claim 17, wherein the at least one air outlet louver is a plurality of air outlet louvers.

19. The operating space, particularly for a motor vehicle, according to claim 17, wherein in the blocking position the air-permeable flow cross section of the air outlet passage opening is generally zero.

20. The operating space, particularly for a motor vehicle, according to claim 12, wherein the insulating lining material includes a thermally and acoustically insulating lining material which has one or more porous layers and at least one gas-impermeable barrier layer.

21. The operating space according to claim 17, wherein the air intake passage opening and the air outlet passage opening are disposed a distance apart in the direction orthogonal to the air intake passage opening.

22. The operating space according to claim 21, wherein the air intake passage opening and the air outlet passage opening at least partially overlap when viewed in the direction orthogonal to the air intake passage opening.

23. The operating space according to claim 17, wherein the air intake passage opening and the air outlet passage opening are disposed parallel to each other.

24. The operating space according to claim 12, wherein the operating space is an engine compartment in which an internal combustion engine and a heat exchanger which employs a cooling medium are disposed, wherein the air intake passage opening is disposed upstream of the heat exchanger in an air flow direction.

25. The operating space according to claim 17, wherein the operating space is an engine compartment in which an internal combustion engine and a heat exchanger which employs a cooling medium are disposed, wherein the air intake passage opening is disposed upstream of the heat exchanger in an air flow direction.

26. The operating space according to claim 17, wherein the operating space is an engine compartment, wherein a tunnel adjoins the engine compartment, which tunnel is employed possibly for accommodating a drive shaft and/or an exhaust pipe and/or a transmission component, wherein the at least one air outlet louver is disposed in a transition region from the engine compartment to the tunnel, such that by actuating the at least one air outlet louver an air flow and/or a sound propagation between the engine compartment and the tunnel can be influenced.

27. An operating space, particularly for a motor vehicle, possibly for accommodating an internal combustion engine, which space is bounded by an enclosure, wherein more than half of the enclosure surface comprises a thermally and acoustically insulating lining material, and/or is formed from thermally and acoustically insulating lining material, wherein the operating space adjoins a tunnel which tunnel is employed possibly for accommodating a drive shaft and/or an exhaust pipe and/or a transmission component, wherein an air louver system comprises an air passage opening and at least one air louver, the at least one air louver being adjustable between an open position, in which the opening cross section of the air passage opening is larger, and a closed position, in which the opening cross section of the air passage opening is smaller, the air louver system being disposed in a transition region from the operating space to the tunnel, such that by actuating the at least one air louver an air flow and/or a sound propagation between the operating space and the tunnel can be influenced.

28. The operating space, particularly for a motor vehicle, according to claim 27, wherein in the closed position the opening cross section of the air passage opening is generally zero.

29. The operating space, particularly for a motor vehicle, according to claim 27, wherein the at least one air louver is a plurality of air louvers.

30. The operating space, particularly for a motor vehicle, according to claim 27, wherein more than 75% of the enclosure surface comprises the thermally and acoustically insulating lining material.

31. The operating space, particularly for a motor vehicle, according to claim 27, wherein the tunnel is bounded by a thermally and acoustically insulating lining material, at least in the region of the tunnel immediately adjoining the operating space.

32. The operating space, particularly for a motor vehicle, according to claim 26, wherein the tunnel is bounded by a thermally and acoustically insulating lining material, at least in the region of the tunnel immediately adjoining the operating space.

33. A motor vehicle having an operating space, particularly an engine compartment, the operating space is bounded by an enclosure, wherein more than half of the enclosure surface comprises an insulating lining material and/or more than half of the enclosure surface is formed from insulating lining material, the enclosure cooperating with an air intake louver system at an intake location, wherein the air intake louver system comprises an air intake passage opening and at least one air intake louver, the at least one air intake louver being adjustable between a passage position, in which the air-permeable flow cross section of the air intake passage opening is greater, so that air can be admitted through the air intake passage opening into the operating space, and a blocking position, in which the air-permeable flow cross section of the air intake passage opening is smaller, so that the amount of air per unit time which can be admitted into the operating space through the air intake passage opening is less than in the passage position.
